(19) United States
(12) Patent Application Publication
(10) Pub. No.: US 2014/0042073 A1
(43) Pub. Date: Feb. 13, 2014

(54) LIQUID FILTER HOUSING WITH HANDLES

(71) Applicants: GINGER ELAYNE PATERA, St. Joseph, MI (US); WESLEY MENDEZ RAMIREZ, Monterrey (MX)

(72) Inventors: GINGER ELAYNE PATERA, St. Joseph, MI (US); WESLEY MENDEZ RAMIREZ, Monterrey (MX)

(73) Assignee: WHIRLPOOL CORPORATION, BENTON HARBOR, MI (US)

(21) Appl. No.: 13/571,403

(22) Filed: Aug. 10, 2012

(51) Int. Cl. B01D 35/30; B23P 11/00

(52) U.S. Cl. 210/238; 29/426.5; 29/428

(57) ABSTRACT

A liquid filter housing with at least one handle molded into its perimeter enclosure, used in a Point of Entry water filtration system, or any similar water filtration system, wherein the handles on the filter housing operate to eliminate the necessity of a separate housing wrench used to detach and reattach the water filter housing during the changing of the filter media at the time of installation or ongoing maintenance.

### BACKGROUND OF THE INVENTION

A Point of Entry (hereinafter, “POE”) water filtration system is primarily a sediment filtration system for the whole house because it connects to the main water line as it enters the house to filter water prior to the water being used by any person or system in house, thereby reducing the sediment levels of the water prior to its use. POE water filtration systems are under high water pressure. Periodically, consumers are required to change the filter media within the water filtration system, in order to maintain optimum performance of the system.

Typical POE water filtration systems have a head to which one end of the filter housing is threaded, leaving the other end free and suspended in air. Ribs are spaced about the periphery of the filter housing. A housing wrench having an opening complementary to the periphery and ribs is slideable over the free end of the filter housing to engage the ribs, thereby enabling the rotation of the housing wrench to unthread the filter housing from the head to replace the filter media. The filter housing must be rethreaded onto the head and tightened enough to create a water tight seal without being over tightened, such that the water filter housing could crack. The wrench required for this process is not a standard size, it is larger than 4 inches in diameter.

Performance of the water filtration system is controlled primarily by the filter media. There are four main types of filter media that are used in POE water filtration systems: string wound, pleated paper, grooved polypropylene microfiber and carbon. Regional location and local water conditions often dictate which type of filter media is most effective. Generally, POE water filtration systems are needed in areas where there are high levels of sediment in the water. Depending on the type of media chosen, the following can be removed or reduced in the water: chlorine, bad taste, odor, cysts, lead, sulfur, algae, turbidity and tannins.

### BRIEF SUMMARY OF THE INVENTION

The invention relates to a liquid filter housing wherein one or more sidewalls form a perimeter enclosure on the outside of the filter housing and a chamber on the inside of the filter housing. The liquid filter housing has at least a top portion and a bottom portion, and a closure at the bottom portion, substantially sealing the bottom portion. The liquid filter housing also has a connector at the top portion that aids in the attachment of the liquid filter housing to a filter head, and at least one handle attached to the outside of the liquid filter housing.

This invention also teaches a method of changing filter media within a liquid filter housing without the use of a housing wrench. The features, advantages, and objects of the present invention will be further understood and appreciated by those skilled in the art by reference to the following specification, claims, and appended drawings.

### BRIEF DESCRIPTION OF THE DRAWINGS

FIG. 1 is a perspective view of a water filter assembly according to a first embodiment of the invention, which includes a filter head, a filter housing with handles and a filter media.

FIG. 2 is an exploded view of the water filter assembly of FIG. 1, with two handles on the outside of the filter housing, the filter media and the filter head.

FIG. 3 is a perspective view of the filter housing of FIG. 1.

FIG. 4 is a top view of the water filter assembly of FIG. 1.

FIG. 5 is a cross sectional view taken along line 5-5 of the water filter assembly of FIG. 1, and further showing the incoming fluid source, bypass valve and home water system in block.

FIG. 6 is a perspective view of a filter housing according to a second embodiment of the invention.

FIG. 7 is a top view of the filter housing of FIG. 6.

FIG. 8 is a perspective view of the filter housing according to a third embodiment of the invention, with the filter housing having a single bottom through-hole handle.

FIG. 9 is a perspective view of the filter housing of FIG. 8, showing use of a common tool as a lever to turn the filter housing.

FIG. 10 is a perspective view of a filter housing according to a fourth embodiment of the invention, with a plurality of through-holes forming an integrated ring handle on the bottom portion of the filter housing.

FIG. 11 is a perspective view of the filter housing of FIG. 10, showing use of a common tool as a lever to turn the filter housing.

### DETAILED DESCRIPTION

This invention relates to liquid filter housings, illustrated herein by water filter housings and systems. The water filter housing must be removed from a water filtration system in order to periodically replace the filter media. Once the filter media is replaced, the water filter housing must be reinstalled into the system. Historically, water filtration system manufacturers have included a housing wrench with their system to enable the consumer to remove the water filter housing and change the filter media. The consumer then uses the housing wrench again to reinstall the water filter housing, trying not to over tighten or over torque the filter housing, which could otherwise result in its cracking and/or leaking. The consumer is then required to maintain and recall the location of the housing wrench each time that the filter media needs to be changed. For some geographic locations, this could be as much as once per week, depending upon the level of sediment or contaminants present in the ground water.

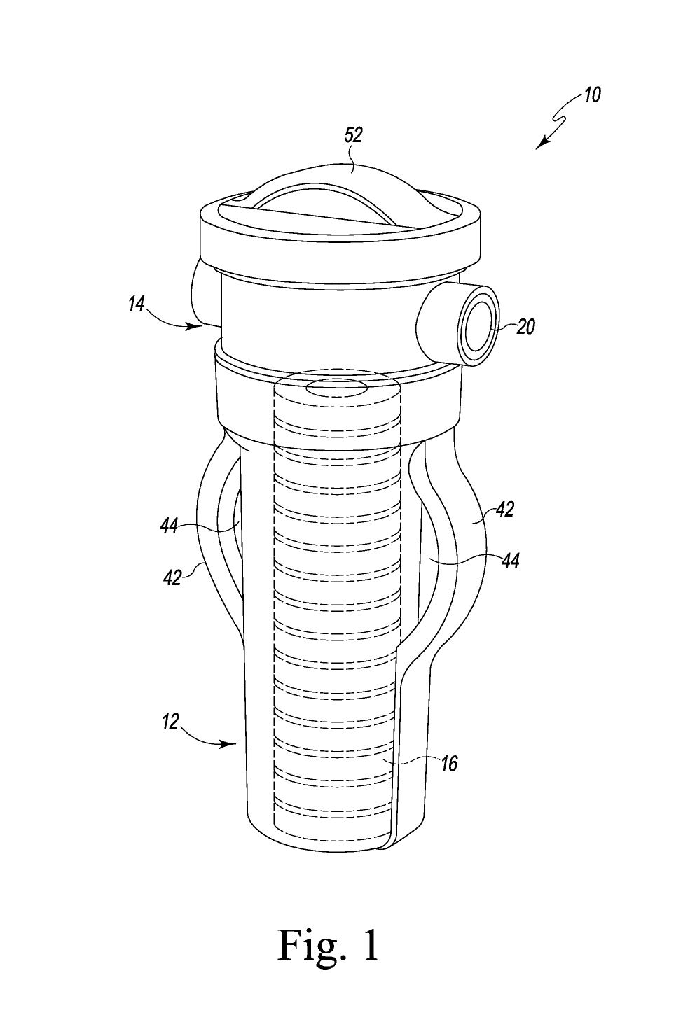

Referring now to the drawings in detail, wherein like numbers indicate the same elements throughout the views, FIG. 1 illustrates a first embodiment of a water filter assembly which is suitable for use in a POE filtration system. The water filter assembly 10 includes a filter housing 12, connected to a filter head 14, which collectively receive a filter media 16.

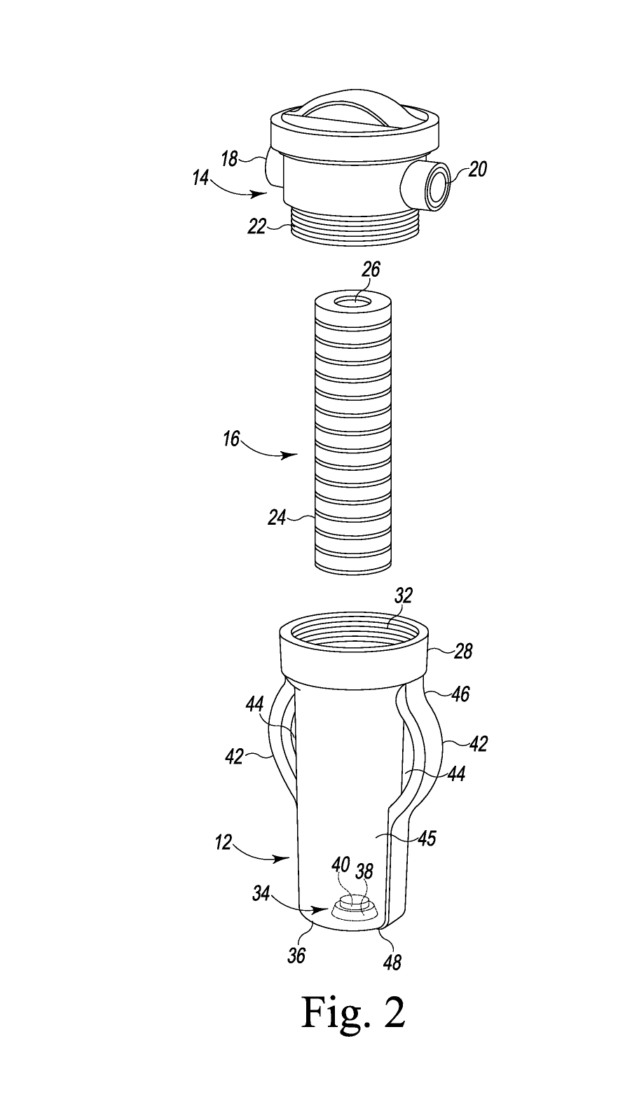

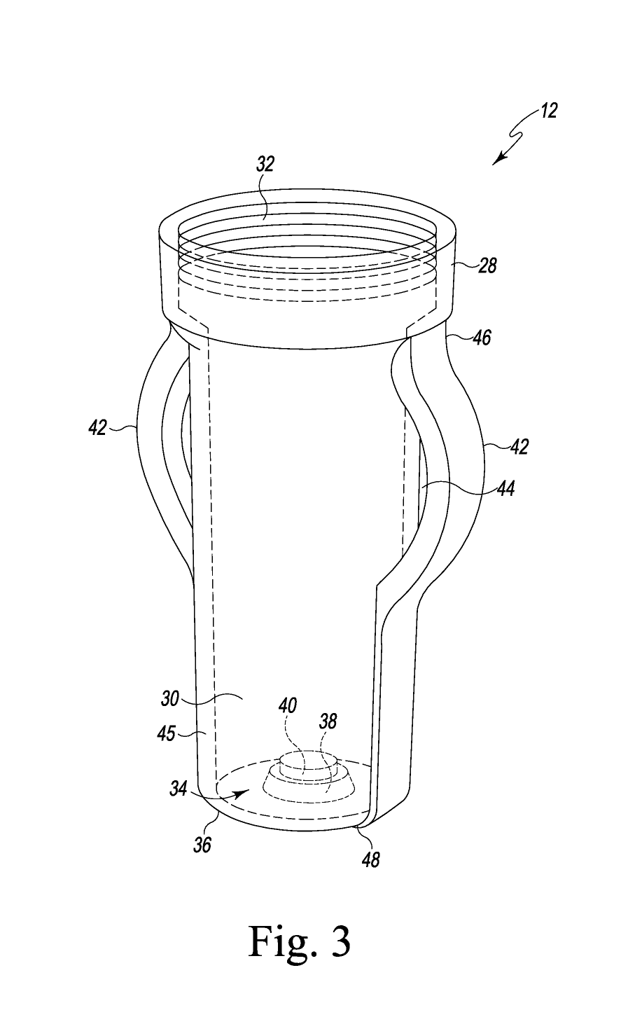

Referring to FIGS. 2 and 3, the details of the filter housing 12, filter head 14, and filter media 16 are seen more clearly. The filter head 14 has a filter head inlet 18, which receives liquid from a fluid source, a filter head outlet 20, which outputs the filtered liquid after it passes through the filter media 16. The filter head inlet 18 and filter head outlet 20 may be any suitable fitting.

A first connector, illustrated as a threaded segment 22 is provided on a lower end of the filter head 14. The filter media 16 has a body defining an outer periphery 24 and a central passage 26. When filtering, fluid is supplied to the outer periphery 24, where it then flows through to the passage 26. In an alternative design, the fluid could also be supplied to the passage 26 and flow outward through the filter media 16.

While the filter media 16 is illustrated as a cylinder with the central passage 26 passing through the center of the cylinder, the filter media 16 may have any desired shape. Depending upon the shape of the filter media 16, additional alternatives for the direction of the fluid flow would also be likely, and determined in part from the shape of the filter media. Further alternatives could include the flow of the fluid from the top of the filter housing 12 to the bottom of the filter housing 12.

The filter housing 12 has an open-top body in the top portion 28 of the filter housing 12. The perimeter enclosure, which is the outside of the filter housing, defines a chamber 30 within the filter housing 12 in which the filter media 16 is received. A second connector or engagement portion, illustrated as a threaded segment 32, is provided at the top portion 28 of the filter housing 12. While the first and second connectors are illustrated as threaded segments, other types of connectors may be used, such as a bayonet connector for example. A stabilizer 34 is provided within the chamber 30 on a closed bottom portion 36 of the filter housing 12. The stabilizer 34 includes a stage 38, provided on the closed bottom portion 36, and an extension 40, which is sized to be received within the central passage 26 of the filter media 16 to stabilize the filter media 16 when it is received within the chamber 30. There are alternative designs that may be employed for stabilizing the filter media 16, such as notches, guide posts, rings or other corresponding shapes to center and stabilize the filter media on the inside of filter housing.

Multiple handles 42, of which there are two in this embodiment, are provided on the exterior of the filter housing 12 and define openings 44 between the handles 42 and the filter housing 12. The handles 42 are integrally molded onto the perimeter enclosure 45 of the filter housing 12 and are tapered in a direction toward the perimeter enclosure 45. The handles have two attachment points, wherein, the first attachment point 46 is closer to the top portion 28 than the second attachment point 48. The handles 42 assist a user in removing the filter housing 12 from the filter head 14 in order to periodically change the filter media 16.

There are three other embodiments herein showing various handle designs. In addition, there may be only one handle around the circumference of the housing attached at one or more points around the filter housing. There could also be a handle that is mounted in a diagonal direction, which could attach at one or more points on the filter housing. Many alternative designs exist that would include various shapes and various types and amounts of attachment points on the filter housing.

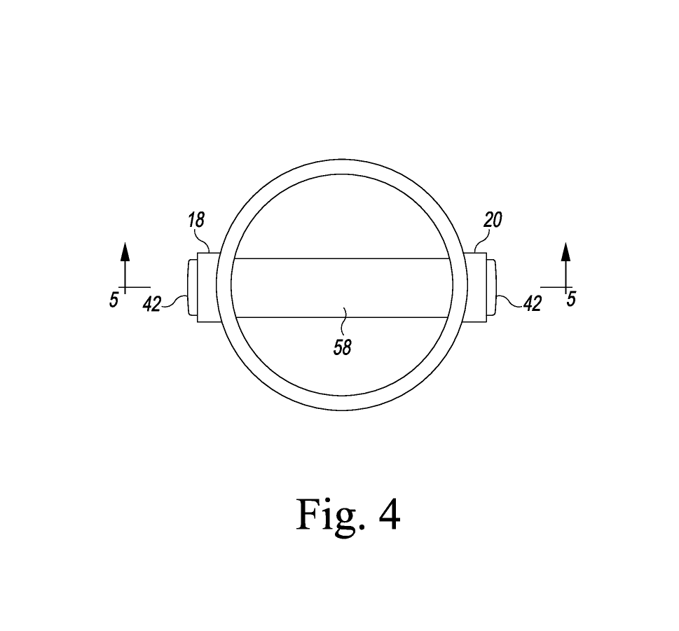

FIG. 4, shows a top view of the water filter assembly 10, with two handles 42 and the filter head inlet 18 and the filter head outlet 20. Also shown is a bypass valve handle 58 on the filter head 14.

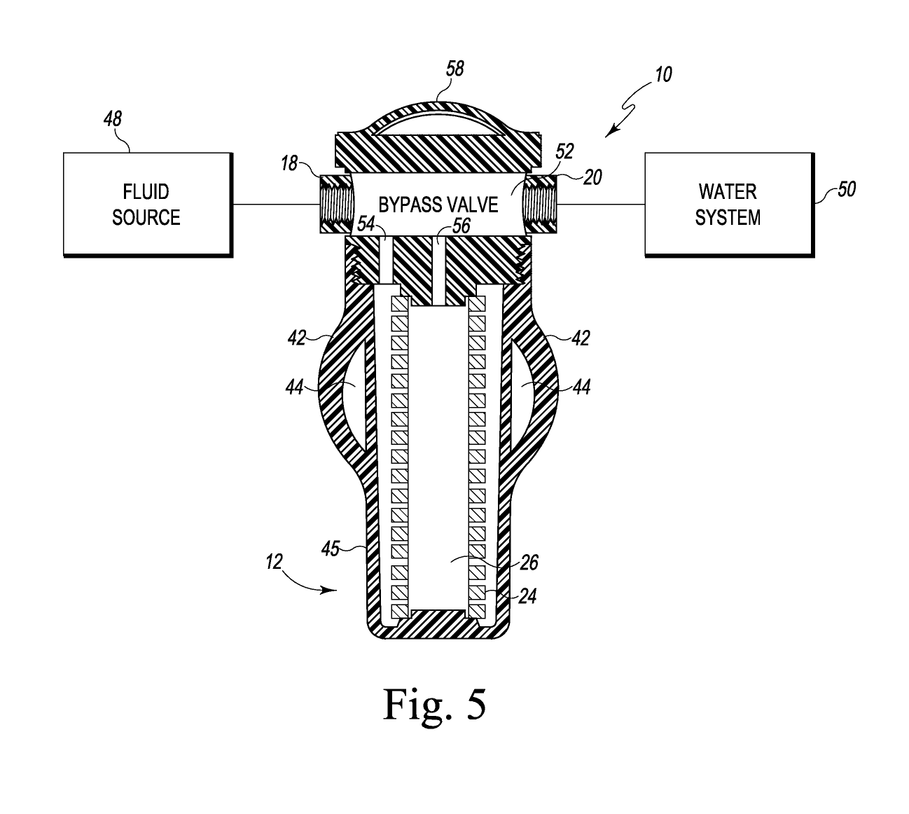

FIG. 5 illustrates the flow of fluid through the water filter assembly 10 wherein the water filter assembly 10 fluidly couples a fluid source 48 to a water system 50. The fluid source 48, which could be a well or a municipal water system, supplies fluid, in this example water, to the entry point of the home. The water system 50 is the water system of a home. At the point of entry into the home, the unfiltered water flows into the water filter assembly 10 through the filter head inlet 18. If the bypass valve 52 is not engaged, the unfiltered water flows into the water filter housing 12, through the incoming fluid passage 54, and through the filter media 16. The filtered water flows through the outgoing fluid passage 56 and then exits the water filter assembly 10 through the filter head outlet 20. The filtered water then flows into the home water system 50.

While the direction of the fluid as herein described, flows from the outside of the filter media 16 inward toward the central passage 26 of the filter media 16 in order to perform the liquid filtration, the fluid could also flow in the opposite direction from the central passage 26 outward through the outer periphery 24 of the filter media 16 and then exit the water filter assembly 10.

The bypass valve 52 is engaged when the user wants to change the filter media 16 without stopping the flow of the fluid source 48 or turning off the water to the house. In that case, the user would engage the bypass valve 52 by turning the bypass valve handle 58. The unfiltered water would then flow through the bypass valve 52 and exit the water filter assembly 10 through the filter head outlet 20. If the bypass valve was not present, the user would need to stop the flow of fluid through the water filter assembly by turning off the water or fluid prior to where the water or fluid enters the water filter assembly.

These types of water filtration systems need to have periodic maintenance, such that the filter media 16 needs to be regularly changed, depending upon the level of sediment or contaminants found in the water from the fluid source 48. In order to change the filter media 16, the user will grasp the handles 42 by inserting his/her fingers into the space 44 between the perimeter enclosure 45 and the handles 42. Once the user has grasped one or more of the handles 42, they can then use the handles to rotate the filter housing 12 in order to break the water tight seal, formed at the connection between the filter head 14 and the filter housing 12. After the user removes the filter housing 12 from the filter head 14, they can then remove the used filter media 16 and insert the replacement filter media. Once again, the user would then grasp one or more of the handles 42 to engage and rotate the filter housing 12 onto the filter head 14. The user can tighten the water filter housing 12 onto the filter head 14 such that a water tight seal is created to prevent water leakage from the water filter assembly 10.

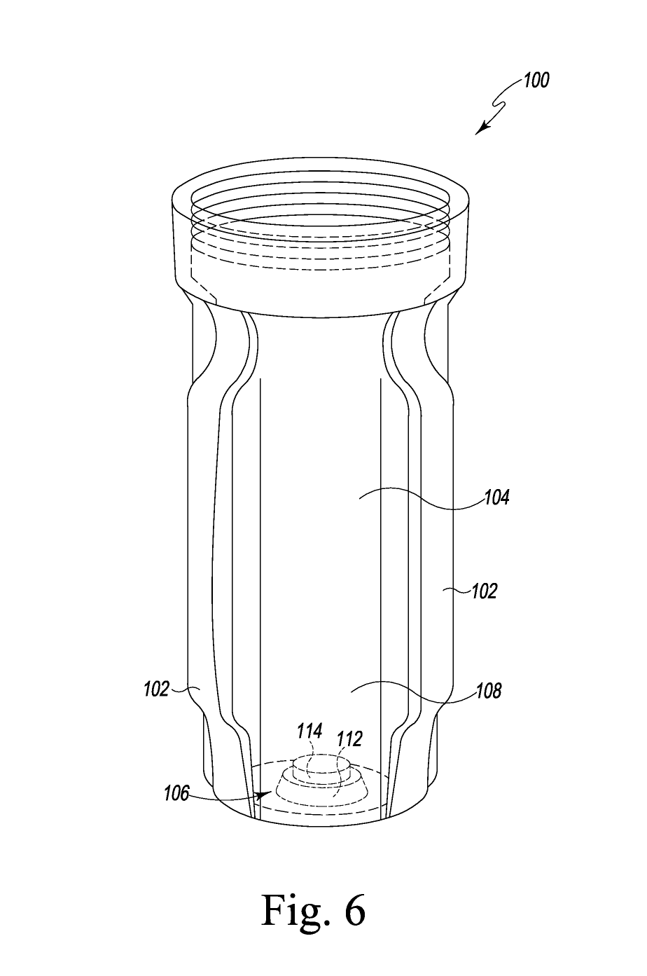

FIG. 6 shows the second embodiment of the invention, which differs from the first embodiment primarily in the configuration of the filter housing 100, which has a plurality of handles 102, which are integrally molded onto the perimeter enclosure 104 of the filter housing 100 and are tapered in a direction toward the perimeter enclosure 104, enabling the easy grasping of the handles 102 by the user. A stabilizer 106 in the chamber 108 is upon a closed bottom portion of the filter housing 100. The stabilizer 106 includes a stage 112, and an extension 114.

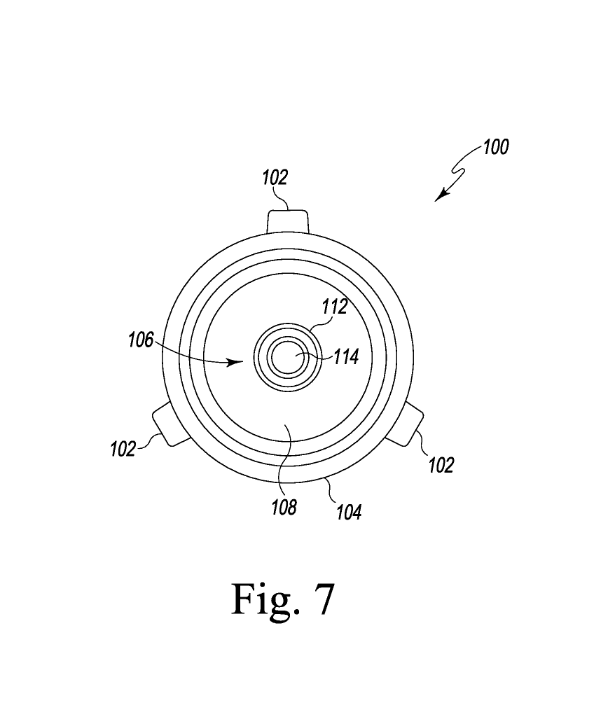

FIG. 7 is a top view of the second embodiment of the filter housing 100, wherein there are three handles 102 integrally molded onto the perimeter enclosure 104 of the filter housing 100 and equally spaced about the perimeter enclosure 104 of the filter housing 100.

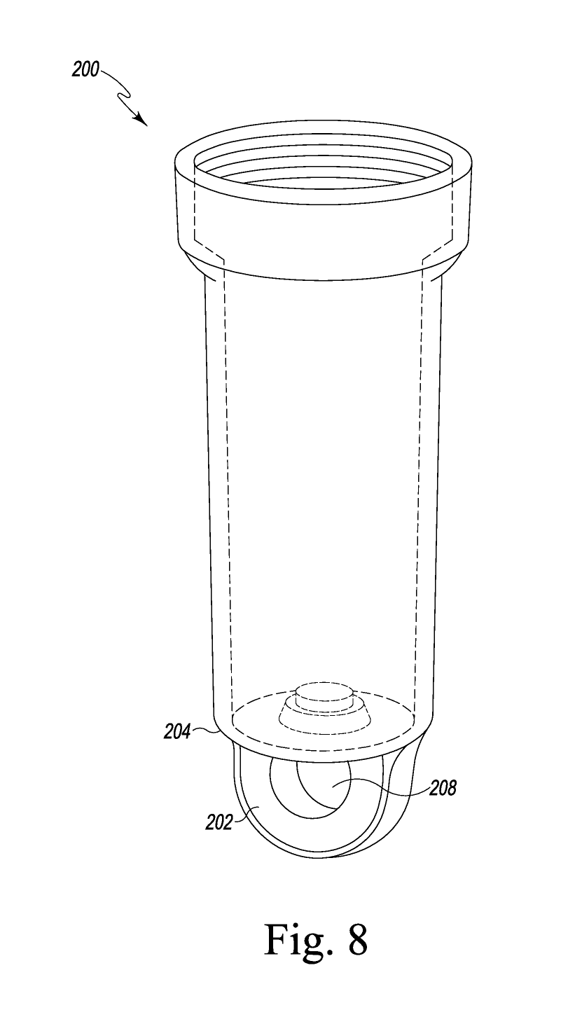

FIG. 8 shows the third embodiment of the invention, which differs from the first embodiment primarily in the configuration of a filter housing 200, wherein the filter housing 200 has one handle 202 integrally attached to the closed bottom portion 204 on the outside of the filter housing 200. The one handle 202 has a single through-hole 208.

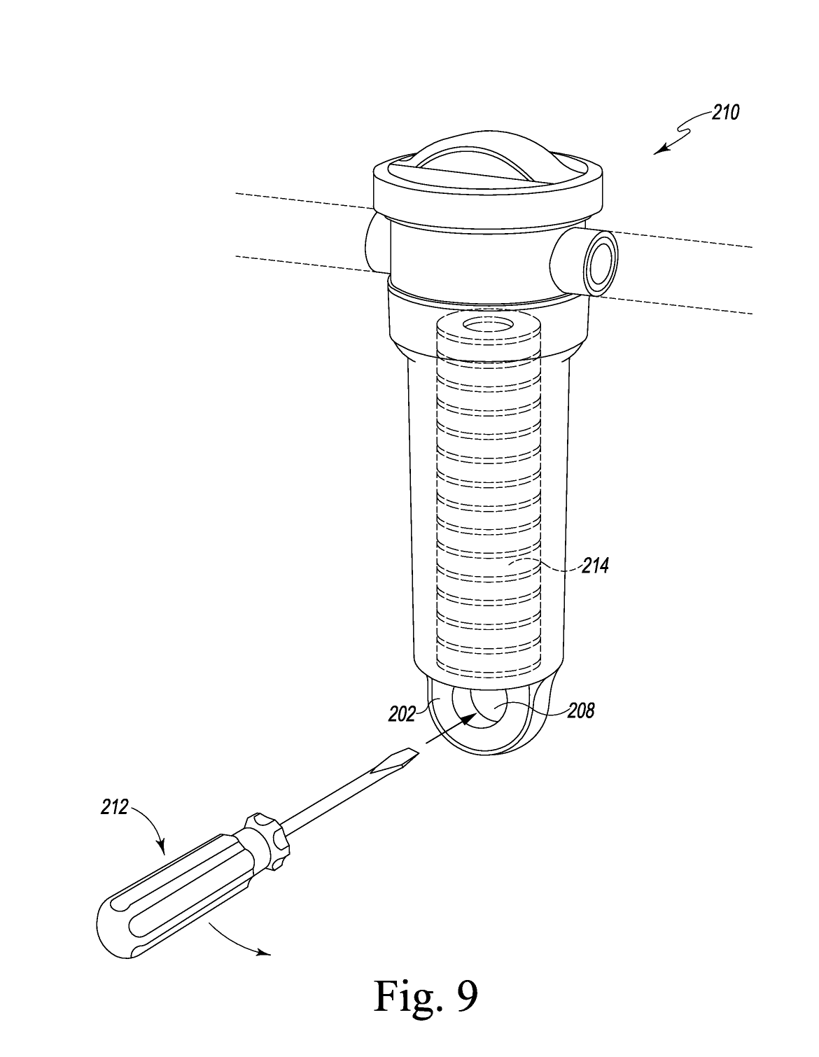

FIG. 9 is a water filter assembly 210 for the third embodiment of the invention, which shows the handle 202 with the single through-hole 208, sufficient to receive the placement of a common tool 212. Once received, the common tool 212 may be used as a lever to turn the filter housing 200 in order to periodically replace the filter media 214. A common tool can include any ordinary tool or straight tool, such as a screw driver, that fits into the through-hole.

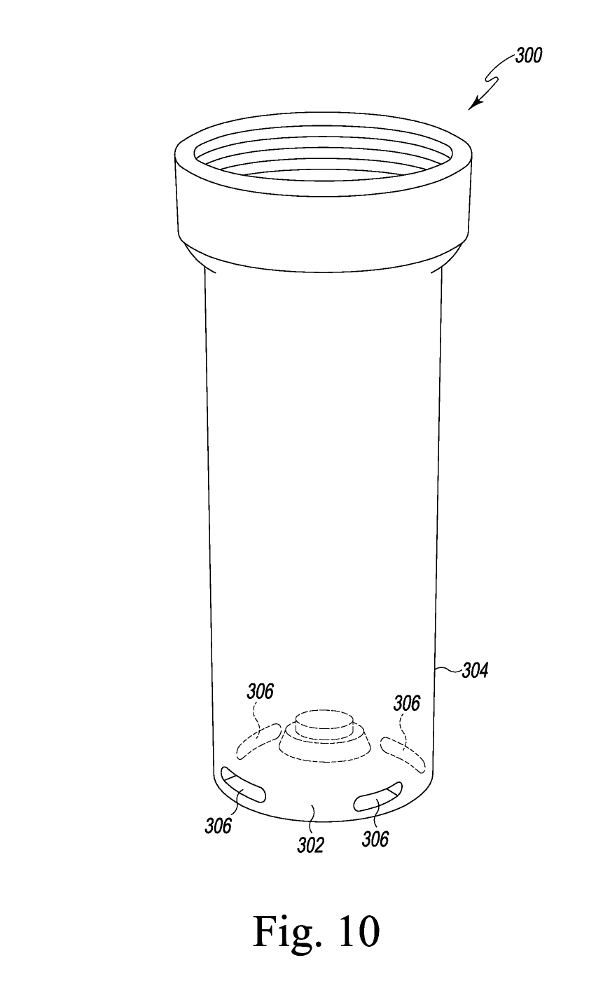

FIG. 10 shows the fourth embodiment of the invention, which differs from the first embodiment primarily in the configuration of a filter housing 300, which shows the filter housing 300 wherein an integrated ring handle 302 extends around the perimeter of the a bottom portion 304 of the filter housing 300 by a plurality of through-holes 306.

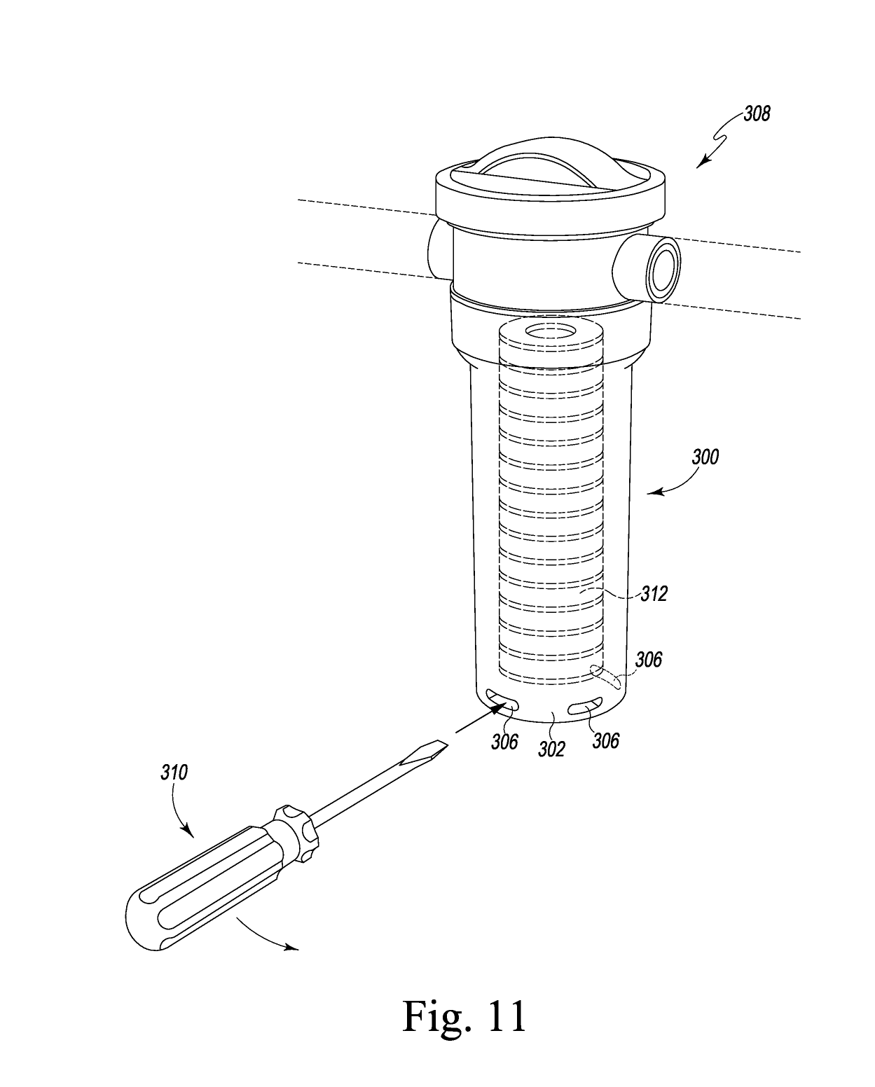

FIG. 11 is a water filter assembly 308, which shows how the plurality of through-holes 306 receive the placement of an ordinary tool 310 through the integrated ring handle 302, thereby allowing the ordinary tool 310 to be used as a lever to turn the filter housing 300 in order to periodically replace the filter media 312. The integrated ring handle 302 could also be positioned anywhere along the outside of the filter housing. A common tool can include any ordinary tool or straight tool, such as a screw driver, that fits into the through-holes.

The disclosure also teaches a method of detaching the filter housing from the filter head without a housing wrench. The method used to detach the water filter housing depends upon where the handle or handles are located on the outside of the water filter housing. Each method begins with the cessation of the water entering the filter head. This can be accomplished by either turning off the water at the source or engaging the bypass function on the filter head. Once that occurs, then the removal options are as follows:
Two handles with a space between each handle and the filter housing: hold two of the handles of the filter housing, one in each hand, by inserting one or more fingers between each handle and the perimeter enclosure and then rotate the filter housing in a first direction until the filter housing disengages from the filter head;
Two or more handles with no space between the handles and the housing: hold two of the handles of the filter housing, one in each hand, and then rotate the filter housing in the first direction until the filter housing disengages from the filter head;
One through hole at the bottom of the filter housing: insert an ordinary household tool to be used as a lever, into the through-hole of the handle attached at the bottom portion of the filter housing, and then rotate the filter housing in the first direction until the filter housing disengages from the filter head; or
Multiple through-holes at the bottom of the filter housing: insert an ordinary household tool to be used as a lever, into the plurality of through-holes of the handle formed at the bottom portion of the filter housing, and then rotate the filter housing in the first direction until the filter housing disengages from the filter head.

The invention also teaches a method of reattaching the water filter housing to a filter head without a housing wrench. This method used to reattach the water filter housing depends upon where the handle or handles are located on the outside of the water filter housing. Once that is determined, then the reattachment options are as follows:
Two handles with a space between the handle and the housing: hold two of the handles of the filter housing, one in each hand, by inserting one or more fingers between the handle and the perimeter enclosure and then rotate the filter housing in a second direction (opposite the first direction) until the filter housing reengages the filter head and is tightly attached to the filter head, in order to prevent water leakage.
Two or more handles with no space between the handles and the housing: hold two of the bumper handles of the filter housing, one in each hand, and then rotate the filter housing in the second direction (opposite the first direction) until the filter housing reengages the filter head and is tightly attached to the filter head, in order to prevent water leakage.
One through hole at the bottom of the filter housing: insert an ordinary household tool to be used as a lever, into the through-hole of the handle attached at the bottom portion of the filter housing, and then rotate the filter housing in the second direction (opposite the first direction) until the filter housing reengages the filter head and is tightly attached to the filter head, in order to prevent water leakage.
Multiple through-holes at the bottom of the filter housing: insert an ordinary household tool to be used as a lever, into the plurality of through-holes of the handles formed at the bottom portion of the filter housing, and then rotate the filter housing in the second direction (opposite the first direction) until the filter housing reengages the filter head and is tightly attached to the filter head, in order to prevent water leakage.

Each method ends with restoring the water supply entering the filter head. This can be accomplished by either turning on the water at the source or disengaging the bypass function on the filter head.

The invention claimed is:

1. A filter housing comprising:
one or more sidewalls forming a perimeter enclosure on the outside and a chamber on the inside, having at least a top portion and a bottom portion, a closure at the bottom portion substantially sealing the bottom portion, a connector at the top portion of the perimeter enclosure, wherein the connector aids in the attachment of the filter housing to a filter head, and at least one handle attached to the perimeter enclosure.

2. The filter housing of claim 1 comprising a single, substantially circular side wall forming the perimeter enclosure.

3. The filter housing of claim 1 wherein the handle is integrally molded into the perimeter enclosure.

4. The filter housing of claim 1 wherein at least one of the handles is tapered in the direction toward the perimeter enclosure.

5. The filter housing of claim 1 wherein at least one of the handles further comprises two attachment points, wherein, the first attachment point is closer to the top portion than the second attachment point.

6. The filter housing of claim 5 wherein at least a portion of one of the handles is spaced apart from the perimeter enclosure sufficiently to allow a user to grasp the handle.

7. The filter housing of claim 1 wherein the engagement portion is substantially in the interior side of the perimeter enclosure and further comprises a plurality of threads.

8. The filter housing of claim 1 wherein the engagement portion is substantially on the exterior side of the perimeter enclosure and further comprises a plurality of threads.

9. The filter housing of claim 1 wherein at least one handle may be attached to the bottom portion of the housing.

10. The filter housing of claim 9 wherein a handle attached to the bottom portion of the housing may have a single through-hole sufficient to receive an ordinary tool.

11. The filter housing of claim 1 wherein an integrated ring handle may be formed at the bottom portion of the filter housing by a plurality of through-holes sufficient to receive an ordinary tool.

12. A method of detaching a water filter housing from the filter head without a housing wrench, optionally selected from the group consisting of:
a. Turning off or bypassing incoming water supply, then holding two of the handles of the filter housing, one in each hand, by inserting one or more fingers between the handle and the perimeter enclosure and then rotating the filter housing in a first direction until the filter housing disengages from the filter head,
b. Turning off or bypassing incoming water supply, then holding two of the bumper handles of the filter housing, one in each hand, and then rotating the filter housing in the first direction until the filter housing disengages from the filter head,
c. Turning off or bypassing incoming water supply, then inserting an ordinary household tool, into the through-hole of the handle attached at the bottom portion of the filter housing to use as a lever, rotating the filter housing in the first direction until the filter housing disengages from the filter head, or
d. Turning off or bypassing incoming water supply, then inserting an ordinary household tool, into the plurality of through-holes of the handles formed at the bottom portion of the filter housing to use as a lever, rotating the filter housing in the first direction until the filter housing disengages from the filter head.

13. A method of reattaching the water filter housing to a filter head without a housing wrench, optionally selected from the group consisting of:
a. Holding two of the handles of the filter housing, one in each hand, by inserting one or more fingers between the handle and the perimeter enclosure and then rotating the filter housing in a second direction, which is opposing to the first direction, until the filter housing is tightly attached to the filter head, then reengaging the water supply by turning on the incoming water supply or turning off the bypass,
b. Holding two of the bumper handles of the filter housing, one in each hand, and then rotating the filter housing in a second direction, which is opposing to the first direction, until the filter housing is tightly attached to the filter head, then reengaging the water supply by turning on the incoming water supply or turning off the bypass,
c. Inserting a common household tool, into the through-hole of the handle attached at the bottom portion of the filter housing and using the screwdriver as a lever, rotating the filter housing in a second direction, which is opposing to the first direction, until the filter housing is tightly attached to the filter head, then reengaging the water supply by turning on the incoming water supply or turning off the bypass, or
d. Inserting a common household tool, into the recesses of the plurality of through-holes formed at the bottom portion of the filter housing and rotating the filter housing in a second direction, which is opposing to the first direction, until the filter housing is tightly attached to the filter head, then reengaging the water supply by turning on the incoming water supply or turning off the bypass.
